(19) United States
(12) Patent Application Publication
(10) Pub. No.: US 2007/0051562 A1
(43) Pub. Date: Mar. 8, 2007

(54) Stairlifts

(76) Inventors: Nigel Titchener, Hampshire (GB); David H. Foster, Hampshire (GB)

Correspondence Address: GRAY, PLANT, MOOTY, MOOTY & BENNETT, P.A., P.O. BOX 2906, MINNEAPOLIS, MN, 55402-0906, US

(21) Appl. No.: 10/566,310

(22) PCT Filed: Jul. 27, 2004
(86) PCT No.: PCT/GB04/03249

§ 371 Date: Jul. 21, 2006

(30) Foreign Application Priority Data
Jul. 28, 2003 (GB) 0317615.3

(51) Int. Cl. B66B 9/08

(52) U.S. Cl. 187/200

(57) ABSTRACT

The present invention enhances the safety of a stairlift by providing a proximity sensor (40, 42) to detect the proximity of users and other objects to a stairlift carriage (20) and to render remote call controls (22, 24) inoperative. A chair occupancy sensor may also be provided to prevent inadvertent operation of the main user control (38) when a user is mounting, or dismounting from, the stairlift.

### FIELD OF THE INVENTION

This invention relates to stairlifts and, in particular, to a method of and/or apparatus for enhancing the safety of a stairlift installation. Whilst the invention has been devised, in particular, for incorporation into curved stairlifts, some aspects of the invention are also applicable to straight stairlifts.

### BACKGROUND TO THE INVENTION

Most stairlift installations include remote call switches mounted at the top and bottom of the stairlift rail. These allow a user to send a call signal to the stairlift in the event that the stairlift carriage is parked at the opposite end of the staircase. In such an instance, the user operating the call switch at a remote location may not be aware of a second user attempting to mount, or dismount from, the stairlift chair. In the case of a curved stairlift, for example, a person standing at one end of the staircase may not be able to see the opposite end of the staircase.

Current stairlift designs typically incorporate a carriage holding switch mounted on an armrest of the chair. When in the ‘off’ position this switch ensures that the stairlift cannot be operated and, when a user is mounting, or dismounting from the stairlift, the stairlift will not move if a call is made to the stairlift from one the remote call switches.

Carriage holding switches on existing stairlift installations are a constant source of inconvenience and/or confusion. Users are instructed to move the switch to the ‘off’ position, at the end of each journey, so that the carriage cannot be moved whilst the user dismounts. The user is further instructed to move the switch to the ‘on’ position, after dismounting, so that the empty chair may be moved under the control of the remote call switches. The switch must then be moved to the ‘off’ position again, for mounting. Given that typical users of stairlifts are elderly, to some extent physically incapacitated, and often easily confused, the need to constantly re-position the carriage holding switch often results in the correct procedure not being adopted. In some instances the carriage holding switch will not be turned off when dismounting the chair. This exposes a user to risk. In other instances, the switch may be left ‘off’ when the chair is empty, thus causing inconvenience to a second user attempting to call the carriage using one of the remote call switches. A further problem with the existing carriage holding switches is that we have observed a tendency amongst some such users to assume that the stairlift is either not working correctly, or broken down, if the carriage holding switch has been inadvertently left in the ‘off’ position. This leads to unnecessary service call-outs.

It is an object of this invention to provide a method of and/or means for controlling the operation of a stairlift which will go at least someway in addressing the aforementioned problems; or which will at least provide a novel and useful choice.

### SUMMARY OF THE INVENTION

Accordingly, in a first aspect, the invention provides a method of enhancing the safety of a stairlift assembly having:—

a rail extending between an upper end and a lower end of a staircase;

a carriage moveable along said rail;

carriage operating controls remote from said carriage;

said method being characterised in that a proximity sensor is provided which is operable to sense a person in the proximity of said carriage, and to render said carriage operating controls inoperative.

Preferably said method includes providing said proximity sensor on or about said carriage.

Preferably a chair is mounted on said carriage, said method further including providing an occupancy sensor to sense when a user is seated on said chair.

Preferably said chair is foldable, said method further including a sensor to sense when said chair is in the folded configuration.

In a second aspect the invention comprises a stairlift installation having:

a rail extending between an upper and lower end of a staircase;

a carriage moveable along said rail; and

carriage operating controls remote from said carriage,

said apparatus being characterised in that a proximity sensor is provided, said proximity sensor being operable to sense the proximity of a person to said carriage and being further operable to, in the event of sensing such a person, rendering said carriage operating controls inoperative.

Preferably said proximity sensor is mounted on or about said carriage.

Preferably said installation further includes a chair mounted on said carriage, part of said proximity sensor being mounted on said chair.

Preferably said proximity sensor is of the capacitance type.

Preferably said installation further includes a load sensor operable to detect the presence of a user seated in said chair.

Preferably said chair is foldable, said installation further including a position sensor operable to sense when said chair is in the folder configuration.

In a third aspect the invention provides a stairlift assembly including:

a rail

a carriage mounted on said rail for movement there-along;

a chair mounted on said carriage;

at least one user operable control to cause movement of said carriage along said rail,

said assembly being characterised in that an occupancy sensor is provided to sense the presence of a user seated in said chair and to activate said user operable control only when a user is seated in said chair.

Preferably said occupancy sensor comprises a load sensor incorporated in said chair and/or carriage.

Many variations in the way the present invention can be performed will present themselves to those skilled in the art. The description which follows is intended as an illustration only of one means of performing the invention and the lack of description of variants or equivalents should not be regarded as limiting. Wherever possible, a description of a specific element should be deemed to include any and all equivalents thereof whether in existence now or in the future. The scope of the invention should be determined by the appended claims alone.

### BRIEF DESCRIPTION OF THE DRAWINGS

One preferred form of the invention will now be described with reference to the accompanying drawings in which:

FIG. 1: shows a plan view of a typical curved stairlift installation;

FIG. 2: shows an isometric view of a stairlift carriage and chair including various components which contribute to the present invention;

FIG. 3: shows, diagrammatically, the operation of a stairlift installation according to the invention with a user standing in proximity to the chair and carriage;

FIG. 4: shows a similar view to FIG. 3 but with the user mounting, or dismounting from, the stairlift chair; and

FIG. 5: shows a similar view to FIGS. 3 and 4 but with the user folding or unfolding the chair.

### DETAILED DESCRIPTION OF WORKING EMBODIMENT

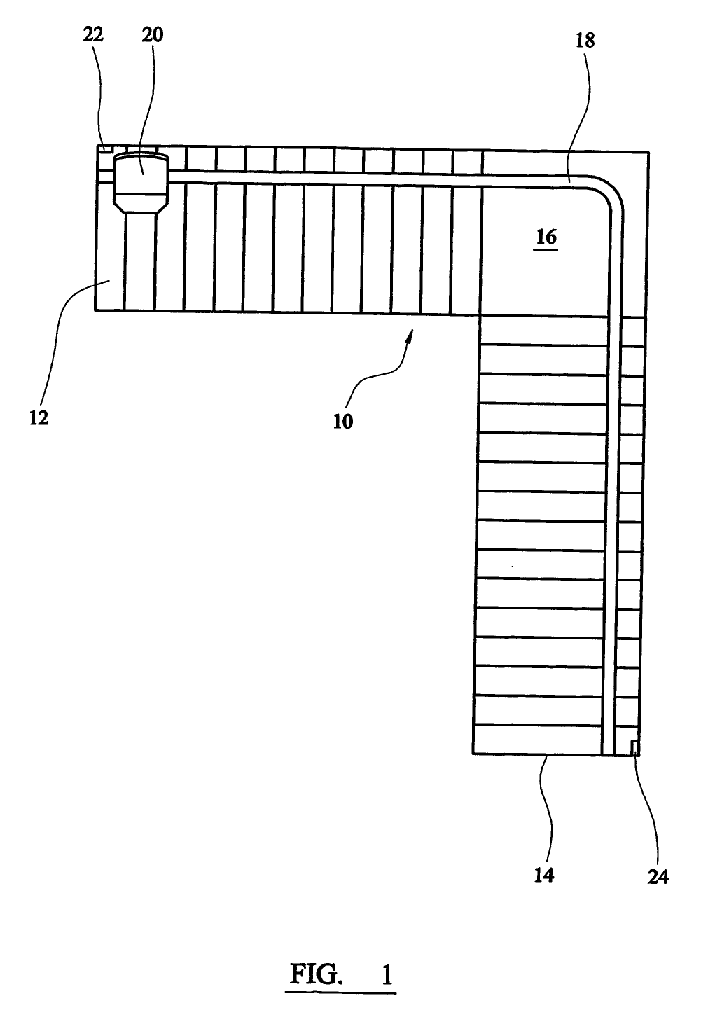

Referring firstly to FIG. 1, the invention provides a method of and/or means for, enhancing safety of a stairlift installation mounted in staircase 10. In the form shown the staircase has an upper end 12, a lower end 14 and an intermediate landing 16. In accordance with conventional practice, a stairlift rail 18 is mounted to one side of the staircase and extends between the upper end 12 and lower end 14. A stairlift carriage and chair assembly 20 is mounted on the rail 18 for movement along the rail between the ends 12 and 14.

Also in accordance with conventional practice, landing controls or call switches 22 and 24 are provided on the staircase walls at or adjacent to the upper end 12 and lower end 14 respectively of the staircase. These landing switches, which could also be portable hand-held units, allow for a user to send a call signal to the stairlift in the event the carriage/chair 20 is parked at a location remote from the switch being activated. Thus, as illustrated in FIG. 1, operation of the control 24 would be used to call the carriage and chair to the lower end 14 of the staircase.

It will be appreciated that a person or user, located at the lower end 14 of the staircase illustrated in FIG. 1, would be unable to see the carriage and chair 20. Thus, if the carriage holding switch on the chair 20 were in the ‘on’ position, and a user was attempting to mount or dismount from the chair 20, any motion of the carriage induced by operation of switch 24 would be undesirable.

In accordance with one aspect of the invention a proximity sensor is provided to sense the proximity of a user to the carriage. In the event close proximity is detected, the controls 22 and 24 are rendered inoperative.

The proximity sensor is preferably included in the carriage/chair 20 but could be mounted in some other position on the staircase and be aligned and programmed to detect the proximity of a person to the carriage. By way of example, the proximity sensor is preferably of the capacitance type which uses an antenna/electrode to detect change in capacitance. As will be appreciated, such a system detects the difference in capacitance between the antenna and a user. The standard system consists of an antenna and a control circuit, the control circuit detecting the difference in capacitance between the antenna and any object within proximity. The control circuit typically further includes a sensitivity capacitor connected to the antenna and a control board which allows the sensitivity of the sensor to be altered by adjusting the value of the capacitor. If desired the control circuit may be configured such that it sends out a ‘heartbeat’ signal allowing the health of the device to be monitored by the main stairlift control system.

It will be appreciated that the precise form of the proximity sensor does not form part of the invention. Whilst a capacitance type sensor is described herein, other types could be used equally effectively including ultrasonic and infrared-based devices.

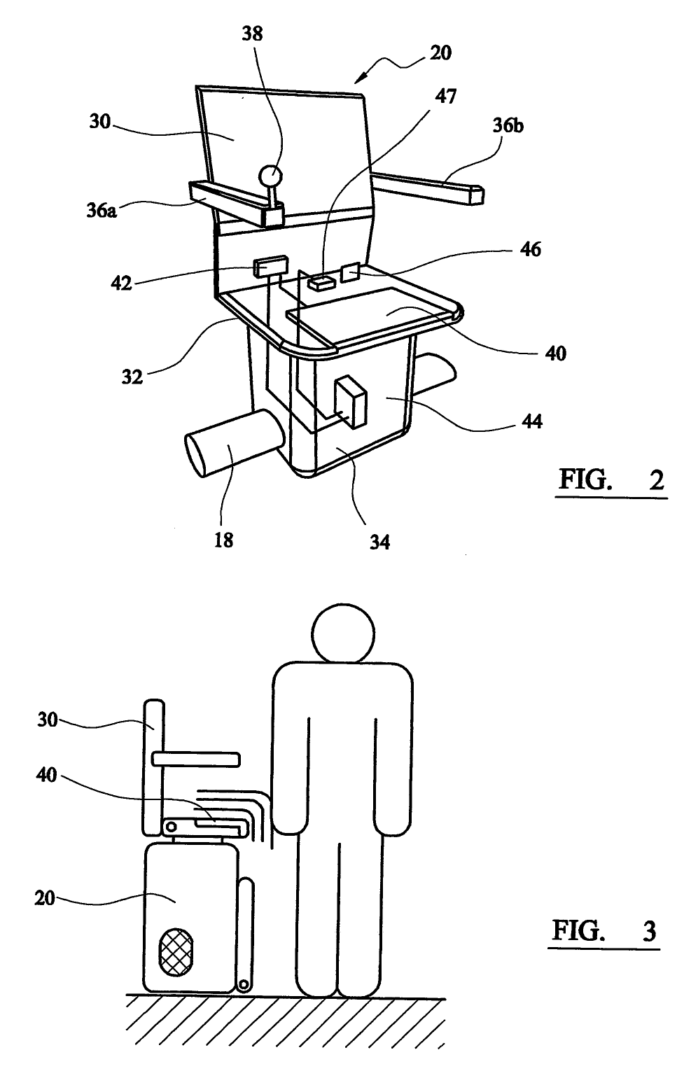

Referring now to FIG. 2, the stairlift carriage/chair assembly 20 is depicted mounted on rail 18. As can be seen the assembly includes a chair back 30 and a chair base 32 mounted on carriage chassis 34. The chair also includes arm rests 36a and 36b. Mounted at the outer end of armrest 36a is a conventional hand control 38 by means of which a user seated in the chair may control the movement of the carriage/chair 20 along the rail 18.

Mounted in the forward part of the chair base 32 is the antenna 40 of the proximity sensor described above, signals from the antenna 40 being fed to proximity sensor circuit 42 and, in turn, to the main stairlift control unit 44 mounted in the carriage.

Also mounted on or adjacent to the chair base 32 are a pair of further sensors 46 and 47. The sensor 46 serves to detect the presence of a person seated in the chair, preferably by detecting load on the chair base 32 as would be imparted by a user sitting thereon. The sensor 47 serves to detect when the chair base 32 is folded up into the position shown diagrammatically in FIG. 5, by arranging one or more contacts within the folding mechanism which execute a switching function when the chair is folded.

The sensors and control unit are programmed to operate as follows:—

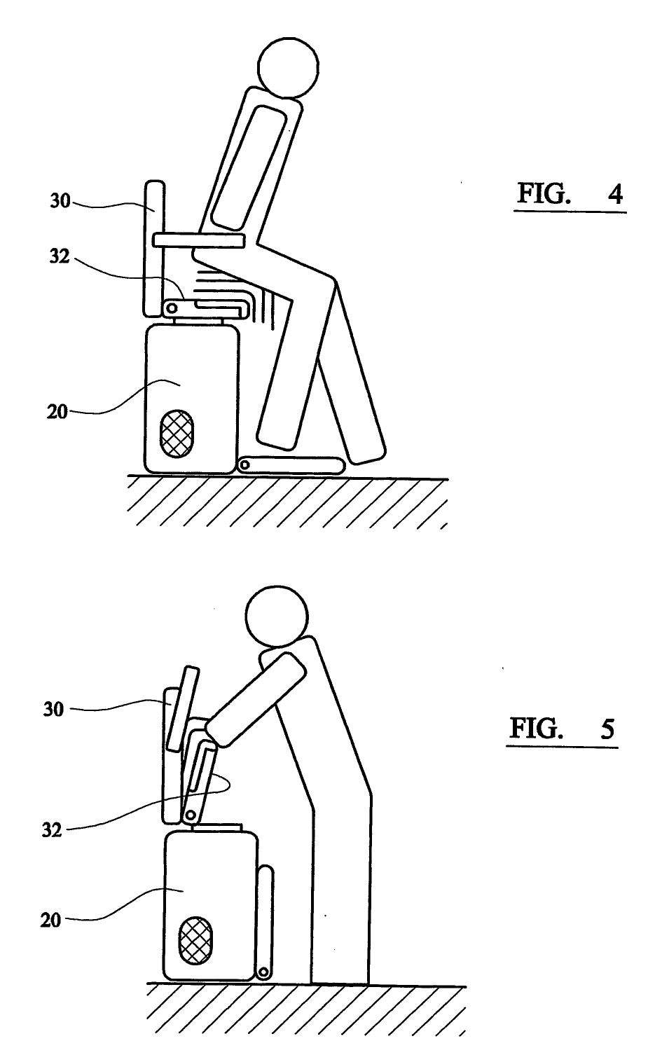

As described above, the proximity sensor of which antenna 40 is a principal part, serves to detect if a person is standing alongside the carriage chair assembly as is illustrated in FIG. 3; or is in the course of mounting, or dismounting from, the chair as is illustrated in FIG. 4. In either event, a signal is provided by the proximity sensor circuit 42 to the main operating control unit 44 of the stairlift and the landing controls 22 and 24 are isolated. This then prevents the carriage/chair assembly 20 being operated by a second user to whom, for example, the carriage/chair 20 is not visible.

In a similar manner the sensor 46 detects when the user is, or is not, seated in the chair, and renders the hand controls 38 inoperative when there is no user seated in the chair. This prevents movement of the carriage/chair 20 if the user inadvertently touches or leans on the controls 38 when mounting, or dismounting from, the chair.

The combination of sensors 40 and 46 also allows the stairlift to be controlled remotely by one user when another user is a passenger in the chair, a feature sometimes referred to as attendant control. In this event, when the sensor 46 detects that a user is seated in the chair, the isolation imposed by the proximity sensor is over-ridden and the carriage/chair 20 again falls under the control of call switches 22 and 24.

The sensor 47 serves to detect when the chair is folded into the position shown in FIG. 5. When the chair is folded as shown in FIG. 5, the proximity sensor described above may not operate in the desired manner. When the chair is folded the antenna may experience a change of signal due to the presence of the chair back 30 (depending on the location of the sensor within the chair) and thus isolate the call switches 22 and 24. However, in practice, it is desirable for the carriage to be under the control of the landing controls 22 and 24, when the chair is in the folded configuration. Thus, by arranging for sensor 47 to determine when the chair is in the folded configuration, the isolation imposed by the proximity sensor may be over-ridden and the carriage and chair assembly 20 again left under the control of the landing controls 22 and 24.

It will thus be appreciated that the present invention, at least as included in the working embodiment described above, enhances stairlift safety whilst obviating the inconvenience arising from the use or misuse of conventional carriage holding switches currently provided on stairlift carriages.

We claim:

1-13. (canceled)

14. A method of enhancing safety of a stairlift installation comprising a rail extending between upper end and lower ends of a staircase, a carriage moveable along the rail, and carriage operating controls remote from the carriage, the method comprising: providing a proximity sensor to disable the carriage operating control when a person is proximate the carriage.

15. The method of claim 14, in which providing the proximity sensor comprises mounting the proximity sensor proximate the carriage.

16. The method of claim 14, in which a chair is mounted on the carriage, and the method further comprises providing an occupancy sensor to sense when a load is applied to the chair.

17. The method of claim 16, in which the chair is foldable, the method further comprising providing a sensor to sense when the chair is folded.

18. A stairlift assembly, comprising a rail extending between an upper and lower end of a staircase; a carriage moveable along the rail; and carriage operating controls remote from the carriage; the assembly comprising: a proximity sensor to sense the proximity of a person to the carriage and to render the carriage operation controls inoperative in response to sensing the proximity of the person.

19. The assembly of claim 18, in which the proximity sensor is mounted proximate the carriage.

20. The assembly of claim 18, further comprising a chair mounted on the carriage, and in which at least part of the proximity sensor being mounted on the chair.

21. The assembly of claim 20, further comprising an occupancy sensor to detect presence of a user seated in the chair.

22. The assembly of claim 21, in which the occupancy sensor comprises a load sensor to sense load on a chair base.

23. The assembly of claim 20, in which the chair is foldable, the assembly further comprising a position sensor to sense when the chair is folded.

24. The assembly of claim 18, in which the proximity sensor is a capacitance type proximity sensor.

25. A stairlift assembly including: a rail; a carriage movably mounted on the rail; a chair mounted on the carriage; at least one user operable control to cause movement of the carriage along the rail; and an occupancy sensor to sense the presence of a user seated in the chair and to activate the user operable control only when a user is seated in the chair.

26. The assembly of claim 25, in which the occupancy sensor comprises a load sensor, incorporated in the chair, operable to sense load applied by a user seated in the chair.

27. The assembly of claim 25, in which the occupancy sensor comprises a load sensor, incorporated in the carriage, operable to sense load applied by a user seated in the chair.
